(19) United States
(12) Patent Application Publication
(10) Pub. No.: US 2015/0240844 A1
(43) Pub. Date: Aug. 27, 2015

(54) Multi Function Band

(71) Applicant: Noa Christian, Santa Barbara, CA (US)

(72) Inventor: Noa Christian, Santa Barbara, CA (US)

(21) Appl. No.: 14/544,741

(22) Filed: Feb. 10, 2015

Related U.S. Application Data
(60) Provisional application No. 61/966,019, filed on Feb. 14, 2014.

(51) Int. Cl. F16B 2/08; D05B 23/00; D05B 1/04; A45D 8/34; A45D 8/36

(52) U.S. Cl. CPC F16B 2/08; A45D 8/34; A45D 8/36; D05B 1/04; D05B 23/00

(57) ABSTRACT

A multi-function band and method therefore having a material formed into a body and an adjuster coupled with the body and accessible to the user wherein the user can use the band as is for applications or withdraw a variable portion of the adjuster causing the material to be gathered into a formation for use in applications.

### CROSS REFERENCE TO RELATED APPLICATIONS

The present application claims the benefit of the filing date of U.S. Provisional Patent Application Ser. No. 61/966.019, filed Feb. 14, 2014, and entitled “Multi Function Band”.

### BACKGROUND OF THE INVENTION

### Description of the Related Art

The present invention relates to bands for use in variety of utilitarian and adornment applications or functions.

Bands have been used for many different applications, such as hair bands, protective bands, athletic bands, etc. However, these bands are limited to specific applications or functions.

Thus, there is a need in the art for a band which can be used for a wide variety of applications or functions with a simple operation by a user; which may be re-used repeatedly for any of these applications as the user desires; and which is economical to produce.

### SUMMARY OF THE INVENTION

A band operable by a user for use in a plurality of applications comprising: a material formed into the body of the band; an adjuster coupled with the body and accessible to the user; and wherein the user can use the band as is for applications or withdraw a variable portion of the adjuster causing the material to be gathered into a formation for use in applications.

The band as described above further comprising one or more adjuster openings in the body for access by the user to the adjuster.

The band as described above wherein the adjuster openings are reinforced.

The band as described above wherein the adjuster openings are holes in the material.

The band as described above wherein the reinforcement is an eyelet.

The band as described above wherein the adjuster openings are made by not joining together portions of the material when the body is formed.

The band as described above wherein the adjuster openings may be disposed in various locations for creating different appearances of the material when gathered by operation of the adjuster.

The band as described above further comprising an adjuster disposition means for loosely coupling the adjuster to the body.

The band as described above wherein the adjuster is comprised of a material with elastic-like qualities.

The band as described above further comprising an adjuster securing means for securing the adjuster in the variably withdrawn position selected by the user.

The band as described above wherein the material has absorbent qualities.

The band as described above wherein the material has decorative patterns thereon.

A band, operable by a user, for use in a plurality of applications comprising: a material formed into the body of the band, the body having a cavity there through one or more openings through the body to the cavity; an adjuster, disposed within the cavity and accessible to the user through the openings; wherein the user can use the band as is for applications or withdraw a variable portion of the adjuster from the body causing the material to be gathered into a formation for use in applications.

A method for forming a band from one or more pieces of material, such band operable by a user for use in a plurality of applications, comprising the steps of: forming two or more layers of material; closing sides of open layers of the material opposite each other; creating a material opening by not closing a certain portion of one such opposite side; forming one or more adjuster openings; pulling each remaining open end of the material layers through the material opening; closing such pulled open material layers; pulling the closed material layers back through the material opening thereby hiding the closings of the material layers from view and forming a looped band having one or more cavities there through; and disposing an adjuster within the cavities such that the adjuster is accessible to the user through the one or more adjuster openings.

The method as described above further including the step of closing the material opening.

The method as described above wherein one or more portions of the material opening is not closed thereby forming the adjuster openings.

The method as described above wherein the material layers are created by folding a piece of material.

The method as described above wherein the step of forming one or more adjuster openings comprises leaving one or more openings in the closing of the pulled open material layers.

The method as described above wherein the step of forming one or more adjuster openings comprises forming a hole in a layer of the material for each adjuster opening.

The method as described above further comprising the step of reinforcing the adjuster openings.

### BRIEF DESCRIPTION OF THE DRAWINGS

FIG. 1a is a functional diagram of the multi-function band depicting the external side.

FIG. 1b is a functional diagram of the multi-function band depicting the internal side.

FIG. 1c is a functional diagram of the multi-function band showing both the internal and external sides.

FIG. 2 is a functional diagram of the multi function band with the adjuster not pulled.

FIG. 3 is a three dimensional depiction of the multi function band with the adjuster partially pulled.

FIG. 4 is a three dimensional depiction of the multi function band with the adjuster fully pulled.

FIG. 6a is a functional diagram of a material used to make the multi function band.

FIG. 6b is a functional diagram of the material with adjuster openings added.

FIG. 6c is a functional diagram of the material having been folded.

FIG. 6d is a functional diagram of the folded material having been partially closed along a dimension a leaving a material opening.

FIG. 6e is a functional diagram of the partially closed folded material depicting a directional arrow for pulling the material through the material opening.

FIG. 6f is a functional diagram of the pulled material depicting material folded again and the closing of the open layers of material.

FIG. 6g is a functional diagram depicting the material having been pulled back through the material opening and the adjuster having been disposed in the band and accessible to the user via the adjuster openings.

FIG. 6h is a functional diagram of the finished band with the material opening closed.

FIG. 7a is a functional diagram of a material used to make the multi function band.

FIG. 7b is a functional diagram of the folded material having been partially closed along a dimension a leaving a material opening.

FIG. 7C is a functional diagram depicting an alternative method of making the adjuster openings.

### DETAILED DESCRIPTION

While various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

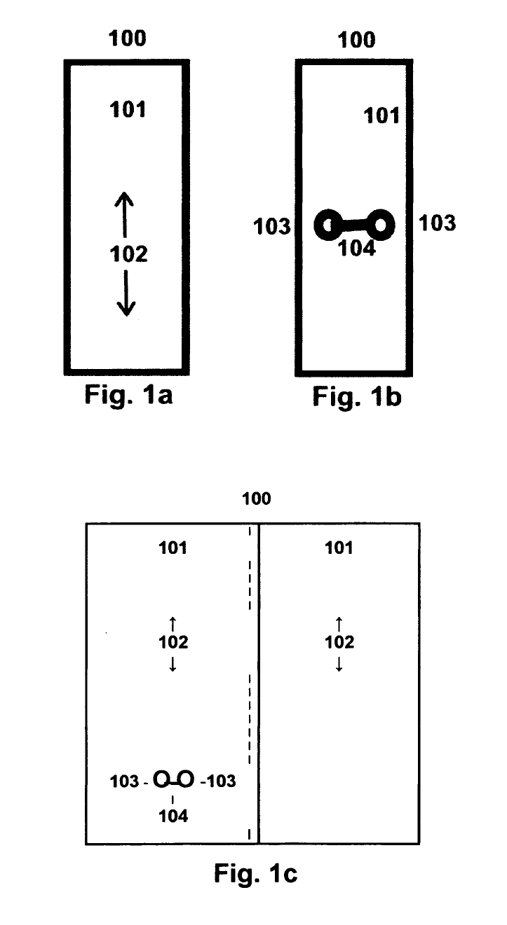

Referring now to FIG. 1a, a functional diagram of the multi function band 100 is depicted showing the external side of the band 100. The band is comprised of a material or fabric 101 which is formed into a circular band with a cavity 102. It will be understood that a wide variety of materials or fabrics 101 such as cotton lycra can be used for the band 100 with qualities, including, but not limited to, absorbency, insulation, elasticity, durability, washable, etc., and any color or combinations of colors. Additionally, the material 101 may have patterns or designs and may have images, patches, logos, lettering, and many other forms of decorations etc. therein and/or thereon.

Referring now to FIG. 1b, a functional diagram of the multi function band 100 is depicted showing the internal side of the band 100. A pair of openings 103 through the material 101 and an accessible portion of a band adjuster 104 are also depicted. The openings 103 are formed by making holes in the material 101 and are reinforced with eyelets or other suitable devices for protecting the material 101 when the adjuster 104 is operated. It will be appreciated that the openings 103 may be reinforced with any suitable device such as, for example, eyelets, grommets or stitching or may not be reinforced at all. Moreover, it will be appreciated that the openings may be formed in a variety of ways such as, for example, leaving openings in the stitching of the material 101 to form the band 100 as described below. It will be further appreciated that the band 100 may have only one opening 103 or more than two openings 103 with which to operate the adjuster 104.

The adjuster 104, as shown in FIG. 1b is formed in to a loop primarily disposed within the cavity 102 of the band 100 and accessible to a user through the adjuster openings 103. It will also be appreciated that the adjuster 104 may have other shapes such as, for example, a single, linear piece of material. It will be further appreciated that the adjuster 104 may be coupled to the material 101 in other ways such as, for example, coupling or attaching it along the internal side circumference of the band 100 and such ways of coupling may eliminate the need for the cavity 102 and/or the openings 103. Moreover, the disposition of the adjuster 104 may be varied such that the material 101 is gathered in different ways.

Referring to FIG. 1c, a functional diagram of the band 100 is shown wherein both the internal side on the left and external side on the right of the band 100 are visible. The material 101 and the cavity 102 are depicted on both sides of the band 100 while the openings 103 and adjuster 104 are visible on the internal (left) side of the band 100.

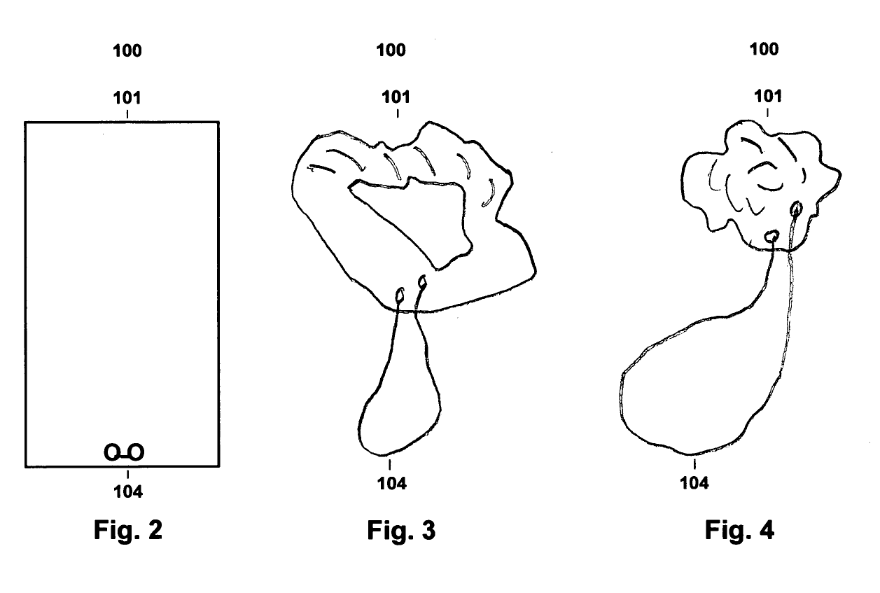

In operation, the band 100 may be used for a plurality of applications or functions when the adjuster 104 has not been operated as depicted in FIG. 2. As the user operates or pulls the adjuster 104, more of the adjuster is withdrawn from the cavity 102 thereby gathering the material 101. FIG. 3 illustrates the band 100 with the adjuster 104 partially operated or withdrawn from the cavity 102 and the material 101 partially gathered. The band 100 may be also used for a plurality of applications or functions in this partially operated mode. FIG. 4 illustrates the band 100 with the adjuster 104 at maximum operation or withdrawal and the material 101 maximally gathered. Similarly, in this maximally operated mode of the adjuster 104, the band 100 may be used for a plurality of applications or functions.

It will also be appreciated that there are a plurality of ways or means for securing the adjuster 104 of the band 100 when partially or maximally operated or withdrawn. For example, the band 100 may be equipped with one or more adjuster securing devices (not shown), such as hooks or clips disposed in proximity to the adjuster openings 103, and into which the withdrawn adjuster 104 may be inserted to secure the adjuster 104 at the desired point of operation or withdrawal. Alternatively, the withdrawn adjuster 104 may be secured by other means such as twisting or with one or more loops around the object or body part where the band 100 will be used.

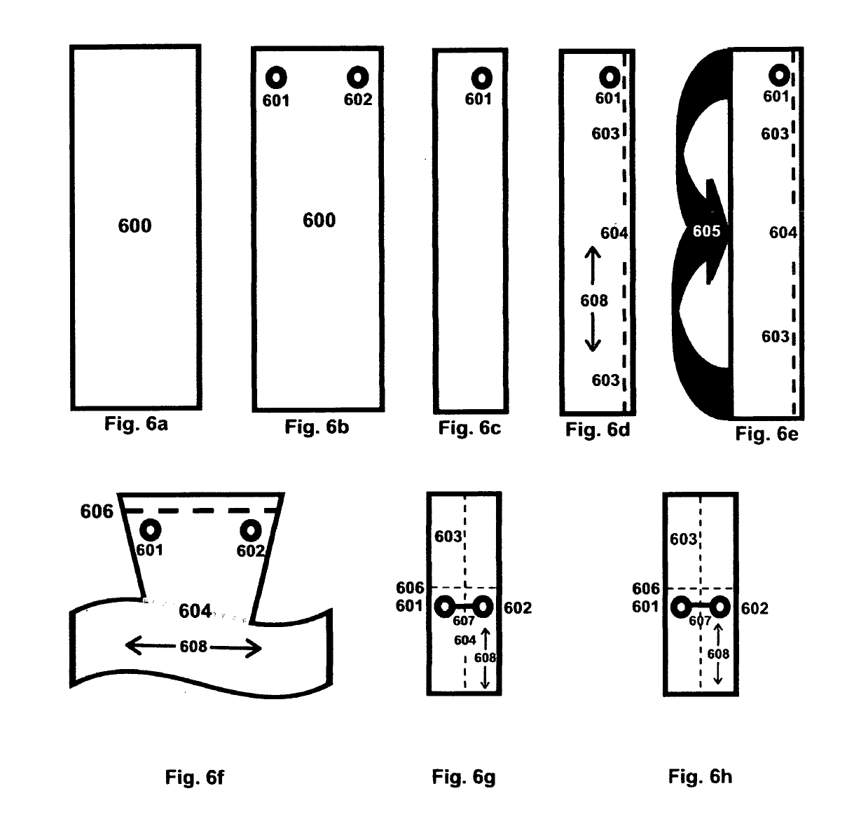

Referring now to FIGS. 6a through 6h, a method or process for making the multi-function band 100 is depicted. FIG. 6a depicts a piece of material or fabric 600 with which the body of the band 100 is formed. It will be understood that a plurality of material shapes can be used.

Referring now to FIG. 6b, the adjuster openings 601 and 602 are made by any suitable method near the edge of the material 600 and preferably along a shorter dimension of the material 600. It will be understood that, alternatively, other locations for the adjuster openings may be used and that one adjuster opening or more than two adjuster openings may be employed within the scope of the present invention.

Referring now to FIG. 6c, the material 600 has been folded along a longer dimension of the material 600, creating layers of the material. Only one of the adjuster openings 601 is visible and the other adjuster opening 602 is now on the underside of the folded material 600.

Referring now to FIG. 6d, the open side of the layers of material, located opposite the fold in the material 600 is closed by stitching or any suitable method as represented by broken lines 603. A material opening 604 is created by not closing a portion of such open side as represented by the break in the dosing 603. Closing the open side of the folded material 600 creates a cavity 608. It will be understood that, within the scope of the present invention, alternative methods for forming layers of material and creating one or more cavities 608 may be employed, such as using two or more equal size pieces of material 600 and also closing the other side with another closing 603.

Referring now to FIG. 6e, a material directional arrow 605 is depicted for pulling the open ends of the material layers through the material opening 604.

Referring now to FIG. 6f, the open ends of the material layers have been pulled through the material opening 604, opened and closed by a single stitching 606 or other suitable methods. The cavity 608 is now completely closed except for the adjuster openings 601 and 602 and the material opening 604.

Referring now to FIG. 6g, the material layers have been pulled back through the material opening 604 thereby hiding the stitching 606 and forming a looped multi-function band 100 as shown in FIG. 1c. The band has been repositioned so that the location of the material opening 604 is visible and moved away from the side. This repositioning brings both adjuster openings 601 and 602 into view and forms the interior side of the band 100 as depicted in FIG. 1b. Also in FIG. 6g, the adjuster 607 has been inserted into and through the cavity 608 using the material opening 604 and then, one end of the adjuster 607 has been inserted out through an opening, 601 for example, and back into the cavity 608 through the other opening, 602 for example. The ends of the adjuster 607 have been joined together by any suitable means such as, for example, tying, fusing, clamping, etc. For aesthetic purposes, the joint of the joined ends of the adjuster 607 has been left within the cavity 608 to hide it from view. It will be appreciated that there are other methods for disposing the adjuster 607 through the cavity and making it accessible to the user via openings 601 and 602.

Referring now to FIG. 6h, the material opening 604 (not shown) has been closed by any suitable means such as, stitching, for example. Prior to or during the closing of the material opening 604, a portion of the adjuster 607 such as, for example, the joint, may be secured to the seam 603 on or near the material opening 604 to prevent the joint of the adjuster 607 from being pulled out of the an opening 601 or 602. During the step of closing the material opening 604, a label or tag may be partially inserted into the material opening 604 before dosing.

It will be appreciated that there are various alternatives for formation of the one or more adjuster openings 601 and 602. One such alternative would be to eliminate the step of making openings in the material 600 as described for FIG. 6b and to leave one or more smaller openings for the adjuster 607 when closing the material opening 604 as described for FIG. 6h. These alternative adjuster openings may be reinforced with extra stitching or other suitable means.

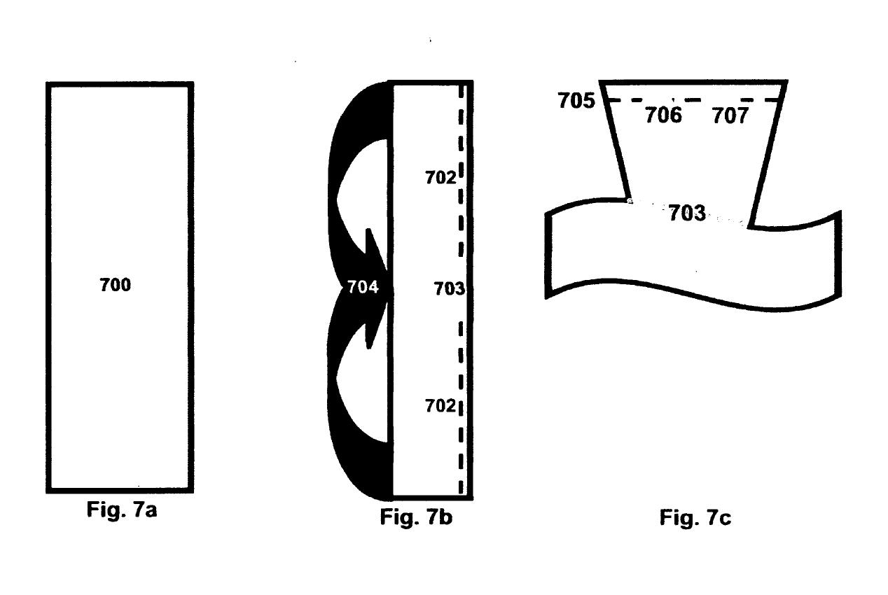

Referring now to FIGS. 7a through 7b, another alternative for formation of the adjuster openings is presented. The material or fabric 700 depicted in FIG. 7a is made into layers in FIG. 7b by folding as described for FIG. 6c. Still referring to FIG. 7b, the closing 702 and the material opening 703 are formed in the same manner as described for FIG. 6d.

Referring now to FIG. 7c, the open material layer ends have been pulled through the material opening 703 in the direction denoted by arrow 704 in FIG. 7b. When the open end of the material layers are closed by stitching 705 or other suitable methods, one or more adjuster openings 706 and 707 are left in the closing seam 705 through the material layers. These adjuster openings may be reinforced by extra stitching or any other suitable means. The band 100 is then completed in the same manner as described for FIGS. 6g and 6h.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A band operable by a user for use in a plurality of applications comprising:
a material formed into the body of the band;
an adjuster coupled with the body and accessible to the user; and
wherein the user can use the band as is for applications or withdraw a variable portion of the adjuster causing the material to be gathered into a formation for use in applications.

2. The band of claim 1 further comprising:
one or more adjuster openings in the body for access by the user to the adjuster.

3. The band of claim 2 wherein the adjuster openings are reinforced.

4. The band of claim 2 wherein the adjuster openings are holes in the material.

5. The band of claim 3 wherein the reinforcement is an eyelet.

6. The band of claim 2 wherein the adjuster openings are made by not joining together portions of the material when the body is formed.

7. The band of claim 2 wherein the adjuster openings may be disposed in various locations for creating different appearances of the material when gathered by operation of the adjuster.

8. The band of claim 1 further comprising:
an adjuster disposition means for loosely coupling the adjuster to the body.

9. The band of claim 1 wherein the adjuster is comprised of a material with elastic-like qualities.

10. The band of claim 1 further comprising:
an adjuster securing means for securing the adjuster in the variably withdrawn position selected by the user.

11. The band of claim 1 wherein the material has absorbent qualities.

12. The band of claim 1 wherein the material has decorative patterns thereon.

13. A band, operable by a user, for use in a plurality of applications comprising:
a material formed into the body of the band, the body having a cavity there through one or more openings through the body to the cavity;
an adjuster, disposed within the cavity and accessible to the user through the openings;
wherein the user can use the band as is for applications or withdraw a variable portion of the adjuster from the body causing the material to be gathered into a formation for use in applications.

14. A method for forming a band from one or more pieces of material, such band operable by a user for use in a plurality of applications, comprising the steps of:
forming two or more layers of material;
closing sides of open layers of the material opposite each other,
creating a material opening by not closing a certain portion of one such opposite side;
forming one or more adjuster openings;
pulling each remaining open end of the material layers through the material opening;
closing such pulled open material layers;
pulling the closed material layers back through the material opening thereby hiding the closings of the material layers from view and forming a looped band having one or more cavities there through; and
disposing an adjuster within the cavities such that the adjuster is accessible to the user through the one or more adjuster openings.

15. The method of claim 14 further including the step of:
closing the material opening.

16. The method of claim 15 wherein one or more portions of the material opening is not closed thereby forming the adjuster openings.

17. The method of claim 14 wherein the material layers are created by folding a piece of material.

18. The method of claim 14 wherein the step of forming one or more adjuster openings comprises;
leaving one or more openings in the closing of the pulled open material layers.

19. The method of claim 14 wherein the step of forming one or more adjuster openings comprises forming a hole in a layer of the material for each adjuster opening.

20. The method of claim 14 further comprising the step of:
reinforcing the adjuster openings.
